(19) United States
(12) Patent Application Publication
(10) Pub. No.: US 2016/0006555 A1
(43) Pub. Date: Jan. 7, 2016

(54) INTEGRATED FRONT MODULE OF SET TOP BOX

(71) Applicant: SAMSUNG ELECTRO-MECHANICS CO., LTD., Gyeonggi-Do (KR)

(72) Inventors: Ho Jin OH, Gyeonggi-Do (KR); Akio TADACHI, Gyeonggi-Do (KR)

(73) Assignee: SAMSUNG ELECTRO-MECHANICS CO., LTD., Gyeonggi-Do (KR)

(21) Appl. No.: 14/324,312

(22) Filed: Jul. 7, 2014

(51) Int. Cl. H04L 5/06; H04N 21/61; H04N 21/238; H04N 7/10

(52) U.S. Cl. CPC H04L 5/06; H04N 7/10; H04N 7/106; H04N 21/6118; H04N 21/238

(57) ABSTRACT

Embodiments of the invention provide an integrated front module of a set top box, including a signal receiver configured to receive broadcasting signals transmitted through different transmission media, a controller configured to control the signal receiver to receive the broadcasting signals and to transform the received broadcasting signals into image and voice signals, and a signal transformer configured to transform and output the image and voice signals into a radio frequency (RF) signal.

### BACKGROUND

1. Field of the Invention

The present invention relates to an integrated front module of a set top box

2. Description of the Related Art

Together with a development of a communications technology, services of supplying predetermined contents to consumers through various transmission media including satellites, power lines, terrestrial wave, cables, and networks by various broadcasting service provides including a broadcasting provider and a cable television provider are quickly spread, and a designated set top box should be used to receive the contents transmitted through the various transmission media. For example, in order to receive the contents provided through the satellite, a set top box for satellite broadcasting should be provided and in order to receive the contents provided through the terrestrial wave, a set top box for terrestrial wave should be provided.

In addition, as described in Korean Patent Publication No. KR 10-2010-0032088, since a triplexer and a radio frequency (RF) modulator are mounted in an independent module form and used in a front module of a set top box according to the related art separately from a broadcasting receiver module (e.g., a low noise amplifier (LNA) for cable broadcasting or a low noise amplifier/power amplifier (LNA/PA) for multimedia over coax alliance (MoCA) transmission and reception, as non-limiting examples), it is very difficult to electrically match the triplexer, and the like mounted in the independent form to a main circuit of the broadcasting receiver module, or the like of a back end and the triplexer, and the like should be separately manufactured to thereby increase manufacturing costs.

### SUMMARY

Accordingly, embodiments of the invention have been made to provide an integrated front module of a set top box capable of easily electrically matching a triplexer and an RF modulator to a main circuit by configuring the triplexer and the RF modulator integrally with a broadcasting receiver module (for example, a low noise amplifier (LNA) for cable broadcasting or a low noise amplifier/power amplifier (LNA/PA) for multimedia over coax alliance (MoCA) transmission and reception, as non-limiting examples).

According to an embodiment of the invention, there is provided an integrated front module of a set top box including a signal receiver configured to receive broadcasting signals transmitted through different transmission media, a controller configured to control the signal receiver to receive the broadcasting signals and transform the received broadcasting signals into image and voice signals; and a signal transformer configured to transform and output the image and voice signals into a radio frequency (RF) signal.

According to an embodiment, the signal receiver includes a signal branching module configured to receive the broadcasting signals transmitted through the different transmission media and then to branch the broadcasting signals into each frequency band, and a signal receiver module configured to receive the broadcasting signals which are branched into each frequency band.

According to an embodiment, the signal branching module is a triplexer.

According to an embodiment, the signal receiver module includes a first receiver module configured to receive a broadcasting signal for cable broadcasting, a second receiver module configured to receive a multimedia over coax alliance (MoCA) signal, and a third receiver module configured to receive a cable modem signal.

According to an embodiment, the first receiver module is a balanced-to-unbalanced transformer (BALUN) and a low noise amplifier (LNA) for cable broadcasting, the second receiver module is the BALUN and a low noise amplifier/power amplifier (LNA/PA) for MoCA transmission and reception, and the third receiver module includes the BALUN.

According to an embodiment, the signal transformer is a RF modulator.

According to an embodiment, the controller is configured to generate a clock (CLK) signal for controlling the LNA for cable broadcasting and the LNA/PA for MoCA transmission and reception

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a block diagram of an integrated front module of a set top box according to an embodiment of the invention.

FIG. 2 is a block diagram of a signal receiver of the integrated front module of the set top box according to an embodiment of the invention.

FIG. 3 is a circuit diagram showing the integrated front module of the set top box according to an embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, preferred embodiments of the present invention will be described in detail with reference to the accompanying drawings.

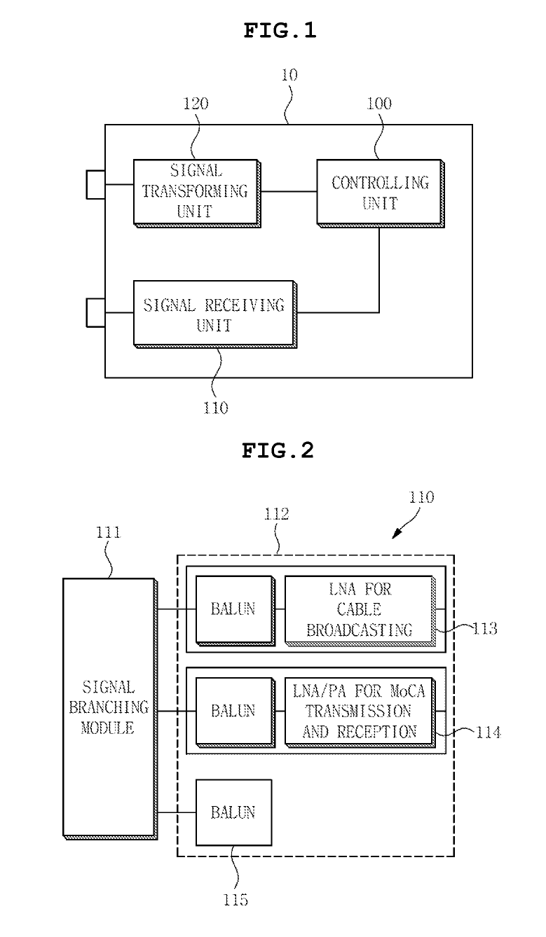

FIG. 1 is a block diagram of an integrated front module of a set top box according to an embodiment of the invention. As shown in FIG. 1, the integrated front module of the set top box according to an embodiment of the invention includes a signal receiver receiving a broadcasting signal, a controller controlling the signal receiver, and a signal transformer transforming a signal generated from the controller into a radio frequency (RF) signal.

According to an embodiment, the signal receiver 110 receives the broadcasting signal transmitted through different transmission media (e.g., cable broadcasting, multimedia over coax alliance (MOCA)) and input to the set top box, as non-limiting examples, wherein the broadcasting signal includes, for examples, RF signals in different frequency bands according to the transmission media).

According to an embodiment, the signal receiver 110 includes a signal branching module 111 receiving the broadcasting signal transmitted through the different transmission media (e.g., cable broadcasting and multimedia over coax alliance (MOCA), as non-limiting examples), and then branching the broadcasting signal into each frequency band, and a signal receiver module 112 receiving the broadcasting signal, which is branched into each frequency band. According to an embodiment, the signal branching module 111 is a triplexer.

According to an embodiment, the controller 100 controls the signal receiver 110 to receive the broadcasting signals including the signals of a plurality of frequency bands and transforms the received RF broadcasting signal into voice and image signals to be suitable for display.

According to an embodiment, the controller 100 generates a clock (CLK) signal having a certain frequency and applies it to the signal receiver 110 in order to control the signal receiver 110, demodulates the received RF broadcasting signal to thereby process the image and voice signals extracted by the demodulation in a base band region (1 kHz).

According to an embodiment, the signal transformer 120 transforms the image and voice signals transformed by the controller 100 into a RF signal form suitable for transmission to a display (not shown). Thus, since the image and voice signals are signals processed in the base band region (1 kHz), the signals are modulated to a RF signal form, which is high frequency form in order to transmit the signals to the display (not shown). According to an embodiment, the signal transformer 120 is a RF modulator transforming image and audio signals into the RF signal.

As described above, in the integrated front module 10 of the set top box, the set top box may be miniaturized and a production process thereof may be simplified by configuring the triplexer and the RF modulator integrally with the broadcasting receiver module (e.g., LNA for cable broadcasting or a LNA/PA for MoCA transmission and reception, as non-limiting examples).

In addition, the integrated front module of the set top box according to embodiments of the invention has the triplexer and the RF modulator manufactured integrally with a main circuit including the broadcasting receiver module at the time of the manufacturing process, such that an impedance matching with the main circuit is easily performed, thereby making it possible to reduce loss in the broadcasting signal received through the integrated front module of the set top box to secure reliability of signal transmission.

Electrical connections and functions of the respective components in the integrated front module of the set top box will be described in more detail below.

FIG. 2 is a block diagram of a signal receiver of the integrated front module of the set top box according to an embodiment of the invention. As shown in FIG. 2, the signal receiver, according to an embodiment of the invention, includes a signal branching module branching the received broadcasting signal and a signal receiver module receiving the branched broadcasting signal.

According to an embodiment, the signal branching module 111 receives the broadcasting signal, which is branched into each frequency band and then branches the broadcasting signal into each frequency band. According to an embodiment, the signal branching module 111 is the triplexer having a low pass filter, a band pass filter, and a high pass filter, which are integrated and configured to separate and filter three frequency bands, respectively.

According to an embodiment, the signal receiver module 112 receives the broadcasting signal, which is branched into each frequency band from the signal branching module 111 and includes a first receiver module 113 receiving a broadcasting signal for cable broadcasting, a second receiver module 114 receiving a MoCA signal, and a third receiver module 115 receiving a cable modem signal. According to an embodiment, the first receiver module 113 is a balanced-to-unbalanced transformer (BALUN) and the LNA for cable broadcasting, the second receiver module 114 is the BALUN and the LNA/PA for MoCA transmission and reception, and the third receiver module 115 is the BALUN.

According to an embodiment, the BALUN is referred to as a circuit transforming a balanced signal into an unbalanced signal, and vice versa, wherein the balanced signal is referred to a signal transmitted along two conductor lines while having the same amplitude over a transmission line transmitting the signal through a combination of two lines.

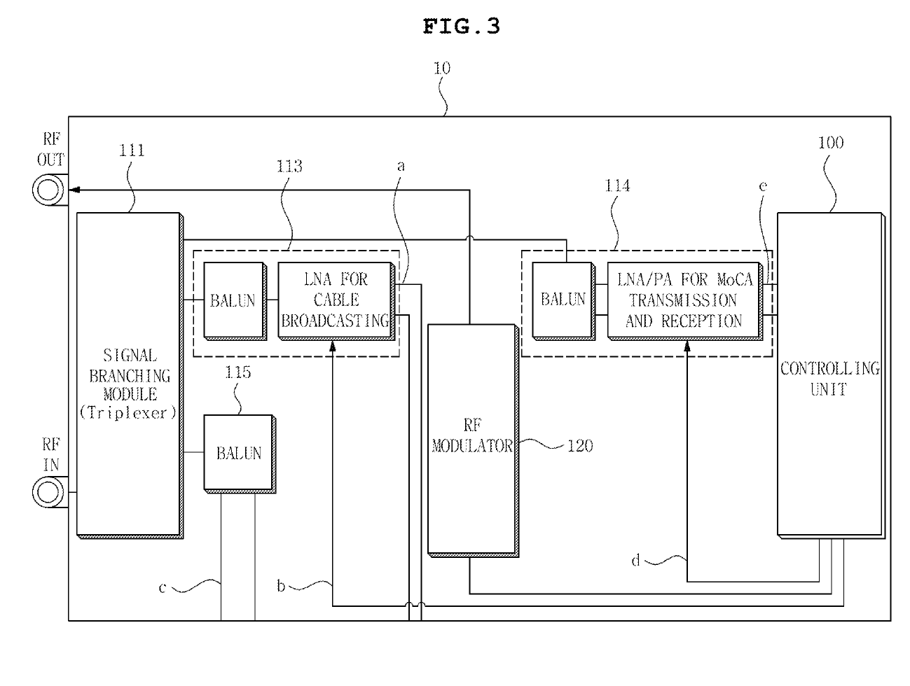

An operation principle of the front module of the set top box will be described in more detail with reference to FIG. 3.

FIG. 3 is a circuit diagram showing the integrated front module of the set top box according to an embodiment of the invention. As shown in FIG. 3, the signal branching module (i.e., triplexer) 111 receives the broadcasting signals transmitted through the different transmission media (e.g., cable, MoCA network, or cable modem, as non-limiting examples) and then filters the signal present in different frequency bands included in the broadcasting signals to thereby branch the respective filtered broadcasting signals into the first to third receiver modules 113, 114, and 115.

According to an embodiment, since the broadcasting signals received by the signal branching module (i.e., triplexer) 111 include signals in the different frequency bands according to the transmission media, a signal for cable broadcasting (e.g., 57 to 1002 MHz) among the broadcasting signals is branched into the first receiver module (e.g., LNA for cable broadcasting) 113, a signal for MoCA home network (e.g., 1115 to 1675 MHz) is branched into the second receiver module (e.g., LNA for MoCA transmission and reception) 114, and a signal for cable modem (e.g., 5 to 42 MHz) is branched into the third receiving module (e.g., BALUN) 115.

According to an embodiment, the signal for cable broadcasting (e.g., 57 to 1002 MHz) input to the first receiver module 113 is transformed into the balanced signal while passing through the BALUN, is low-noise amplified according to an amplification ratio preset by the LNA for cable broadcasting, and is then applied to the controller 100 through a channel a, and a user selects a broadcasting signal of a desired channel among the applied signals for cable broadcasting by using a tuner (not shown). Here, the controller 100 generates a CLK signal for operating and controlling the LNA for cable broadcasting and applies it to the LNA for cable broadcasting through a channel b.

In addition, the signal for MoCA broadcasting (e.g., 1115 to 1675 MHz) applied to the second receiver module 114 is transformed into the balanced signal while passing through the BALUN, is low-noise amplified according to an amplification ratio preset by the LNA/PA for MoCA transmission and reception, and is then applied to a MoCA chip (not shown) in the controller 100 through a channel e. According to an embodiment, the LNA/PA for MoCA transmission and reception receives a feedback of a predetermined signal from the MoCA chip through the channel e and performs a two-way communication with a set top box in other place connected over a home network. In addition, the controller 100 applies CLK signal for operating and controlling the LNA/PA for MoCA transmission and reception to the LNA/PA for MoCA transmission and reception through a channel d.

Next, the signal for cable modem (e.g., 5 to 42 MHz) applied to the third receiver module (BALUN) 115 is transformed into the balanced signal while passing through the BALUN and is then applied to a cable modem (not shown) included in the controller 100 through a channel c. That is, the user may be connected to Internet, for example, through a two-way communication with the cable modem (not shown) of the third receiver module.

According to an embodiment, the signal transformer (RF modulator) 120 receives image and voice signals that the broadcasting signal is transformed through a certain process from the controller 100, modulates the image and voice signals to the RF signal form, which is the high frequency form, and then transmits the modulated image and voice signals to the display (not shown). Thus, the signal transformer 120 transforms the image and voice signals formed in the base band region (1 kHz) into the high frequency RF signal form suitable for transmission to a display (not shown).

As set forth above, according to various embodiments of the invention, unlike conventional front modules of the set top box, the set top box may be miniaturized and the production process thereof may be simplified by configuring the triplexer and the RF modulator integrally with the broadcasting receiving module (e.g., LNA for cable broadcasting or a LNA/PA for MoCA transmission and reception, as non-limiting examples).

In addition, the integrated front module of the set top box according to various embodiments of the invention has the triplexer and the RF modulator manufactured integrally with the main circuit including the broadcasting receiving module at the time of the manufacturing process, such that the impedance matching with the main circuit is easily performed, thereby making it possible to reduce loss in the broadcasting signal received through the integrated front module of the set top box to secure reliability of signal transmission.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. An integrated front module of a set top box, the integrated front module comprising:
a signal receiver configured to receive broadcasting signals transmitted through different transmission media;
a controller configured to control the signal receiver to receive the broadcasting signals and to transform the received broadcasting signals into image and voice signals; and
a signal transformer configured to transform and output the image and voice signals into a radio frequency (RF) signal.

2. The integrated front module of the set top box of claim 1, wherein the signal receiver comprises:
a signal branching module configured to receive the broadcasting signals transmitted through the different transmission media and then branch the broadcasting signals into each frequency band; and
a signal receiver configured to receive the broadcasting signals which are branched into each frequency band.

3. The integrated front module of the set top box of claim 2, wherein the signal branching module is a triplexer.

4. The integrated front module of the set top box of claim 2, wherein the signal receiver module comprises:
a first receiver module configured to receive a broadcasting signal for cable broadcasting;
a second receiver module configured to receive a multimedia over coax alliance (MoCA) signal; and
a third receiver module configured to receive a cable modem signal.

5. The integrated front module of the set top box of claim 4, wherein the first receiver module is a balanced-to-unbalanced transformer (BALUN) and a low noise amplifier (LNA) for cable broadcasting, the second receiver module is the BALUN and a low noise amplifier/power amplifier (LNA/PA) for MoCA transmission and reception, and the third receiver module includes the BALUN.

6. The integrated front module of the set top box of claim 1, wherein the signal transformer is a RF modulator.

7. The integrated front module of the set top box of claim 5, wherein the controller is configured to generate a clock (CLK) signal for controlling the LNA for cable broadcasting and the LNA/PA for MoCA transmission and reception.
